(19) United States
(12) Patent Application Publication
(10) Pub. No.: US 2021/0247810 A1
(43) Pub. Date: Aug. 12, 2021

(54) DISPLAY DEVICE USING SURFACE-MODIFIED, DETACHMENT/ATTACHMENT LAYER

(71) Applicant: Young Su KIM, Suwon-si (KR)

(72) Inventor: Young Su KIM, Suwon-si (KR)

(21) Appl. No.: 16/972,836

(22) PCT Filed: Jul. 3, 2019
(86) PCT No.: PCT/KR2019/008112

§ 371 Date: Dec. 7, 2020

(30) Foreign Application Priority Data
Jul. 9, 2018 (KR) 10-2018-0079156
Jun. 27, 2019 (KR) 10-2019-0077150

(51) Int. Cl. G06F 1/16; G09F 9/30; B32B 27/16; B32B 7/06

(52) U.S. Cl. CPC G06F 1/1652; G09F 9/301; B32B 2307/51; B32B 7/06; B32B 2457/20; B32B 27/16

(57) ABSTRACT

Provided is a display device using a surface-treated detachable layer that freely controls an adhesive force for detachable attachment, easily removes air bubbles, and achieves stable attachment regardless of a shape of a surface. The display device includes an adherend member to which an adhesive member is attached and a detachable control layer located on any one of the adhesive member and the adherend member, wherein the detachable control layer comprises a detachable layer and surface-treated patterns located on the detachable layer and composed of at least ones selected from plasma patterns, corona patterns, and combinations thereof.

### TECHNICAL FIELD

The present invention relates to a display device, and more particularly, to a display device that is capable of being stably detachably attached to a surface regardless of whether the surface is curved or flat, by means of a surface-treated detachable layer.

### BACKGROUND ART

A display device forms a screen by means of a display such as a liquid crystal display (LCD), an organic light emitting diode (OLED), a micro light emitting diode (LED), and an electrophoretic display (EPD). The display is widely utilized for a mobile device like a cellular phone, a smartphone, a tablet computer, and so on and for an information processing machine like ATM, kiosk, and so on. The display device is adopted in a portable device with various functions. The portable device is configured to allow an adhesive member like a protective sheet (protective film or protective glass), window, circuit substrate, touchscreen, back cover, etc.) to be detachably attached to an adherend member. For example, the protective sheet as an adhesive member is detachably attached to the window as an adherend member, the window as an adhesive member to the touchscreen as an adherend member, the touchscreen as the adhesive member to the display as an adherend member, and the back cover as the adhesive member to the display as an adherend member.

On the other hand, it is necessary that the adhesive member like a protective sheet (protective film or protective glass), window, circuit substrate, touchscreen, back cover, etc.) is freely detachably attached to the adherend member. If the adhesive member is damaged, the display device is disassembled and is then assembled again so as to attach the adhesive member to the adherend member again, which is complicated, requires a high cost, and causes environmental problems like generation of electrical and electronic waste. At present, only the protective sheet is detachably attached to the window, but such detachable attachment has to be carried out for all of the adhesive members. Even if the detachable attachment is carried out for all of the adhesive members, the above-mentioned problems may still occur.

Foldable and rollable display devices (hereinafter referred to as flexible display device), which recently emerge as an issue, are foldable or rollable, so that they are structurally weak, are easily broken, and are easy to have scratches. In the flexible display device, if the window is regenerated, for example, due to damages and scratches, the regeneration of the window is more complicated than that in flat, 2.5D, and curved display device. The regeneration of the window needs a substantially high cost, produces a large amount of electrical and electronic waste, and executes processes harmful to the human body. Accordingly, the roles and functions of the protective sheet are important in the flexible display device. If a conventional protective sheet is used for the flexible display device, however, separation or formation of air bubbles occur on a folded portion of the foldable display device and on a starting portion, edges, and a finishing portion of the rollable display device.

If a protective sheet to which a strong adhesive is applied is attached, so as to solve such problems, the protective sheet can be prevented from getting loose and can be reduced in the number of air bubbles generated. However, it is actually hard to attach the protective sheet with the strong adhesive to the window, without having air bubbles. If scratches or damages occur on the attached protective sheet, further, separate process and cost are required to remove the protective sheet, a large amount of electrical and electronic waste is generated, and the processes harmful to the human body are executed. If the protective sheet is forcedly removed, the flexible display device itself may be damaged. If a protective sheet made of a soft material like TPU as disclosed in Korean Patent No. 2009-0021013 is used or an adhesive with a low adhesive force is used, it is difficult to detachably attach the protective sheet due to the generation of air bubbles, and the protecting function is remarkably deteriorated. So as to allow the protective sheet to be detachably attached gently, accordingly, there is a need for developing a detachable layer with an appropriate adhesive force.

The explanation as mentioned above has been limited to the protective sheet, but so as to achieve gentle detachable attachment, the detachable layer with an appropriate adhesive force can be applied to all of the adhesive members. For example, the window as the adhesive member has to be easily detachably attached to the touchscreen as the adherend member, without any separation or generation of air bubbles. Further, the adhesive member has to be stably detachably attached to the adherend member regardless of whether the adherend member is curved or flat.

### DISCLOSURE

### Technical Problem

Accordingly, the present invention has been made to solve the above-mentioned problems, and it is an object of the present invention to provide a display device using a surface-treated detachable layer that is capable of freely adjusting an adhesive force according to positions so that the surface-treated detachable layer can be stably detachably attached to a surface regardless of a shape of the surface.

### Technical Solution

To accomplish the above-mentioned objects, according to one aspect of the present invention, there is provided a display device including an adherend member to which an adhesive member is attached and a detachable control layer located on any one of the adhesive member and the adherend member. In this case, the detachable control layer includes a detachable layer and surface-treated patterns located on the detachable layer and composed of at least ones selected from plasma patterns, corona patterns, and combinations thereof.

According to the present invention, the adhesive member is at least any one selected from module components constituting the display device and a protective sheet. The adherend member is at least any one selected from module components constituting the display device and a protective sheet. The adherend member has a flat shape, a curved shape, or a combined shape thereof. The adherend member is foldable, rollable, or flexible. The detachable layer is provided in any one form of a coating and a sheet. The arrangements of the surface-treated patterns have stripe shapes, lattice shapes, island shapes, fence shapes, and combined shapes thereof.

According to the present invention, the plasma patterns are formed by allowing the detachable layer to be subjected to any one selected from an atmospheric plasma treatment, a low pressure plasma treatment, and a corona plasma treatment. The corona patterns are formed by allowing the surface of the detachable layer to be oxidized to thus express a polar group.

According to the present invention, desirably, the surface-treated patterns are further composed of deposited patterns. Each deposited pattern is a single deposited layer or multiple deposited layers made of at least one selected from titanium oxide (TiO₂), silicon dioxide (SiO₂), gold (Au), silver (Ag), silicon (Si), copper (Cu), palladium (Pd), nickel (Ni), tungsten (W), iron (Fe), cobalt (Co), titanium (Ti), Chrome (Cr), manganese (Mn), zinc (Zn), zirconium (Zr), molybdenum (Mo), iridium (Ir), ruthenium (Ru), tantalum (Ta), and alloys or oxides thereof, and a layer in which a fluoro resin or silicone resin is contained is located on the deposited layer.

To accomplish the above-mentioned objects, according to another aspect of the present invention, there is provided a display device including an adherend member to which an adhesive member is attached and a detachable control layer located on any one of the adhesive member and the adherend member. In this case, the detachable control layer includes a detachable layer and surface-treated patterns located on the detachable layer and composed of deposited patterns.

### Advantageous Effects

According to the present invention, the display device is provided with the detachable control layer that is subjected to the plasma, corona, and deposition treatments, so that the adhesive force of the detachable control layer is freely adjusted according to positions in a process of detachable attachment, thereby allowing stable attachment regardless of a shape of a surface. In addition, the patterns are provided to the detachable control layer, so that the adhesive force of the detachable control layer can be more freely controlled according to positions.

### DESCRIPTION OF DRAWINGS

FIG. 1 is a sectional view showing a display device according to a first embodiment of the present invention.

FIG. 2 is a sectional view showing a display device according to a second embodiment of the present invention.

FIG. 3 is plan views showing examples of surface-treated patterns applied to the display devices according to the first and second embodiments of the present invention.

### MODE FOR INVENTION

Hereinafter, embodiments of the present invention will be described with reference to the accompanying drawings. The embodiments may be embodied in different forms and should not be construed as limited to the embodiments set forth herein but may be modified and variously implemented by those skilled in the art. In the description, the thicknesses of the films (layers or patterns) and regions shown in the drawing may be magnified for the clarity and convenience of the description. It will be understood that when a film (layer or pattern) is referred to as being “on”, “above”, “under”, or “on one surface” of another film (layer or pattern), it can be formed directly on another film (layer or pattern) or other films (layers or patterns) may also be intervened between the two films.

The present invention suggests a display device with a detachable control layer subjected to plasma, corona, and deposition treatments, so that the adhesive force of the detachable control layer is freely adjusted according to positions, thereby achieving stable attachment regardless of a shape of a surface. To do this, explanations on a structure of the detachable control layer and a process of controlling an attachment force to an adherend member through the detachable control layer will be specifically given. According to the present invention, an adhesive member as one component of the display device is detachably attached to an adherend member as another component of the display device. At present, the protective sheet is detachably attached to the window, but according to the present invention, the detachable attachment can be applied to all components of the display device. Hereinafter, an adhesive force indicates a coupling force of a detachable control layer itself and a coupling force of an adhesion control layer itself, and an attachment force indicates a coupling force between the adhesive member and the adherend member.

The display device according to the present invention includes a video processing device, such as a mobile device, an information processing terminal, and a television. The mobile device includes a cellular phone, a smartphone, and a tablet computer, etc., and the information processing terminal includes ATM, kiosk, etc. The display device has a flat surface or curved flat surface, or the display device is flexible. The video processing device necessarily includes a window, a touchscreen, and a display. The window indicates the windows in all video processing devices like a mobile device, an information processing terminal, and a television. Also, the touchscreen and display indicate the touchscreens and displays applied to all video processing devices.

The display device has a flat, curved, or combined shape. The display device is developed sequentially to 2D (flat), 2.5D (front curved edges and flat back), and 3D (curved and edge) display devices according to the shape of a window. Recently, foldable and rollable display devices have been emerged. The foldable and rollable display devices are a kind of a flexible display device. The display device according to the present invention includes all of the flat, curved, and combined shapes, like the 2D, 2.5D, 3D, and flexible display devices.

The display device according to the present invention basically includes a display, a touchscreen, and a window, and a touchscreen cover layer is attached to the touchscreen. Further, the touchscreen cover layer may be replaced with a polarizing film, and a back cover is attached to the opposite side of the window to the display. Accordingly, the module components of the display device according to the present invention necessarily include the display, the touchscreen, and the window and selectively include at least one of the touchscreen cover layer, the polarizing film, and the back cover.

Of course, the display device according to the present invention includes an additional component, for example, a print film, within the scope of the present invention. Further, the display device includes combined components, such as a window with the back printed or coated, a window with the back on which the polarizing film is laid, and a window with the back on which the touchscreen and the polarizing film are laid. Like this, the module components of the display device indicate the display, the touchscreen, the window, the touchscreen cover layer, the polarizing film, the back cover, the additional component, and the combined components. The protective sheet is a protective film made of a high polymer film, protective glass made of tempered glass, or a combination thereof. The protective sheet is attached to the window of the display device to prevent the window from being damaged or to prevent scratches from being generated on the window. Accordingly, the protective sheet is an additional component of the display device.

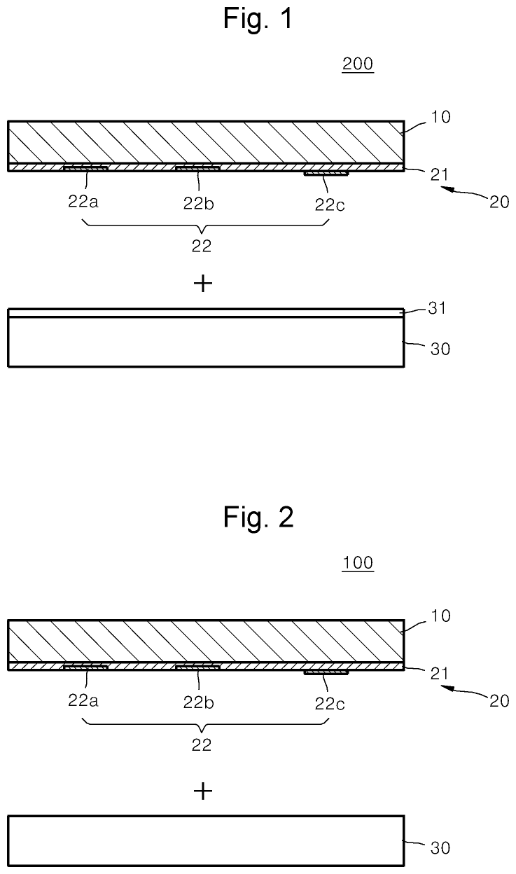

FIG. 1 is an exploded sectional view showing a display device 100 according to a first embodiment of the present invention. However, FIG. 1 is not a specific figure because some of components of the display device 100 are not indicated for the convenience of the description.

As shown in FIG. 1, the display device 100 largely includes an adhesive member 10 and an adherend member 30, and the adhesive member 10 is attached to the adherend member 30 by means of a detachable control layer 20. The adhesive member and the adherend member 30 are ones selected from the module components as mentioned above. According to the present invention, the surface-treated detachable control layer 20 is located on one surface of the adhesive member 10. In some cases, however, the surface-treated detachable control layer 20 may be located on one surface of the adherend member 30. That is, the adhesive member 10 and the adherend member 30 are determined according to the position of the surface-treated detachable control layer 20. In the figure, the surface-treated detachable control layer 20 is located on one surface of the adhesive member 10.

The protective sheet includes a transparent substrate, and if the transparent substrate is made of tempered glass, a scattering prevention film is further provided to prevent the tempered glass from scattering. If the protective sheet is the transparent substrate and the window is made of a transparent material, they can be used without any limitations. For example, the protective sheet and the window include a glass substrate or plastic substrate. More specifically, the glass substrate is tempered glass, and the plastic substrate includes one or more materials selected from polyethylene terephthalate (PET), polyethylene naphthalate (PEN), polyether sulfone (PES), polyimide (PI), polyarylate (PAR), polycarbonate (PC), polymethyl methacrylate (PMMA), and cyclic olefin copolymer (COC). The window is configured to have multiple-layered tempered glass or plastic substrates.

The window has a printed layer that is transparent or expresses various functions. One or more coatings selected from transparent, semi-transparent, and color coatings may be applied to the printed layer. The printed layer is formed by means of inkjet printing using silk print or UV, inkjet printing using thermal curing, or transfer printing. A functional coated layer having the characteristics of shielding, reflection prevention, blue light blocking, electromagnetic wave shielding, and privacy is formed on the transparent substrate and the window, respectively. The functional coated layer is formed by means of wet coating in which a liquid is applied or dry coating like deposition.

The touchscreen is made by forming a conductive pattern on one side or both sides of an insulating layer made of metal oxides or plastic. The metal oxides are generally applied to the conductive pattern and include ITO, ATO, ZnO, Cu, conductive polymers, and silver nanowires. The touchscreen cover layer prevents the touchscreen from being damaged due to impacts or contamination. If the touchscreen cover layer is made of a transparent material, it can be freely used without any limitation. For example, the touchscreen cover layer includes a glass substrate or plastic substrate. More specifically, the glass substrate is tempered glass or non-tempered glass, and the plastic substrate includes one or more materials selected from polyethylene terephthalate (PET), polyethylene naphthalate (PEN), polyether sulfone (PES), polyimide (PI), polyarylate (PAR), polycarbonate (PC), polymethyl methacrylate (PMMA), and cyclic olefin copolymer (COC). However, the plastic substrate is more desirable than the glass substrate. The touchscreen cover layer has a given thickness so that the touchscreen is not damaged in a process of using the display device 100 according to the first embodiment of the present invention.

The polarizing film is a film for distinguishing vertically or horizontally polarized incident light to thus pass or block the incident light. The polarizing film is an optical film that is used for a thin film transistor liquid crystal display device (TFT-LCD) of a laptop computer and a monitor, a camera special effect filter, cinema three-dimensional glasses, and OLED visibility improvement. For example, intensities of light emitted from a backlight of a liquid crystal display module are uniform in every direction, but the polarizing film passes only the light vibrated in the same direction as a polarizing axis therethrough and absorbs or reflects the other light to thus make the light polarized to a special direction. When the polarized light passes through the LCD, arranged directions of liquid crystals by pixel are electrically controlled to change the brightness of the pixels.

Examples of the display include a liquid crystal display (LCD), a light emitting diode (LED), an organic light emitting diode (OLED), a micro LED, and an electrophoretic display (EPD), and the display utilizes quantum dots. The back cover is located on the opposite side to the window to protect the display and is made of transparent tempered glass or opaque plastic.

The detachable control layer 20 includes a detachable layer 21 and surface-treated patterns 22. The detachable layer 21 is formed by means of coating. The coating is performed desirably with a thermosetting resin as an acrylic polymer, a silicone polymer, or a urethane polymer, an adhesive made by mixing a thermosetting resin ultraviolet curable resin and a cross-linking agent, or a mixture or copolymer thereof. In some cases, functional materials like silica gels, nanoparticles, and an anti-static agent are mixed with the detachable layer 21, thereby improving the properties of the detachable layer 21. Further, particles forming the quantum dots are added to the detachable layer 21, thereby improving the optical characteristics of the detachable layer 21.

The detachable layer 21 may be provided to the form of a sheet, not by means of coating. For example, the sheet is made of an acrylic polymer that is made by copolymerizing (a) a (meth)acrylic acid ester monomer with group of carbon number 1-12, (b) a (meth)acrylic acid ester monomer containing hydroxy group, (c) a monomer with an amide group, and (d) a vinyl ester monomer, while having a resin acid value less than 0.1 mgKOH/g and being used for an adhesive composition for a touch panel with permittivity of 3-6. Further, examples of the sheet are a light transmitting pressure-sensitive adhesive sheet as silicone gel and a cross-linked silicone type adhesive sheet.

An example of the detachable layer 21 is a sheet made of an adhesive composition comprising a specific molecular weight of acrylic polymer with alkoxy alkyl acrylate monomers, which has no acid components, and a cross-linking agent, and a solid volume ratio of the sheet comprises 65 to 85 parts by mass of (meth) acrylic resin, 10 to 30 parts by mass of polyoxyalkylene polyol, 1.0 to 5.0 parts by mass of polyisocyanate, and 0.005 to 0.1 parts by mass of tin type catalyst. An acid value is in the range between 0 and 5 mgKOH/g, and a weight average molecular weight of the (meth) acrylic resin is 100,000 to 600,000. Further, another example of the detachable layer 21 is a transparent adhesive sheet with polyoxyalkylene polyol having a number average molecular weight of 500 to 1500. Furthermore, yet another example of the detachable layer 21 is a hydrogel type sheet.

In addition to the examples as mentioned above, the detachable layer 21 may be freely changed within the scope of the present invention. Specifically, the detachable layer 21 is made of a material whose adhesive force is changed well by means of a plasma or corona treatment. Further, the adhesive force of the detachable layer 21 is set in the range of 0.1 to 1,500 gf/25 mm. An adhesive force of the detachable control layer 20 according to the present invention is set in consideration of the adhesive force in a state the detachable layer 21 and the surface-treated patterns 22 are combined with each other. For example, in case where an adhesive force of 500 gf/25 mm is needed for a portion of the detachable control layer 20, adhesive forces of the surface-treated patterns 22 are raised even if the adhesive force of the detachable layer 21 is lower than the adhesive force of 500 gf/25 mm, thereby providing the adhesive force of 500 gf/25 mm.

The surface-treated patterns 22 include at least ones selected from plasma patterns 22a, corona patterns 22b, and deposited patterns 22c. Specifically, the surface-treated patterns 22 include only the plasma patterns 22a, only the corona patterns 22b, or only the deposited patterns 22c. The surface-treated patterns 22 include the combinations of the plasma patterns 22a and the corona patterns 22b, the combinations of the corona patterns 22b and the deposited patterns 22c, or the combinations of the plasma patterns 22a and the deposited patterns 22c. Further, as shown, the surface-treated patterns 22 include all of the plasma patterns 22a, the corona patterns 22b, and the deposited patterns 22c.

Each plasma pattern 22a is formed by means of an atmospheric plasma treatment, a low pressure plasma treatment, or a corona plasma treatment. That is, the surface is chemically cleaned so as to improve the adhesive force of the detachable layer 21 and is also activated to remove organic matters therefrom by means of chemical and physical reactions. The detachable layer 21, which has been subjected to the plasma treatment, changes chemical bonding in a region of several tens of μm from the surface thereof through high energy of ions or electrons. Further, the surface is cut by a given thickness to raise a contact angle. The surface of the detachable layer 21 is chemically or physically activated in such a manner as to respond well to other materials. The surface-treated pattern 22 under the plasma treatment provides surface cleaning through fine foreign matter removal, changes in surface roughness, and formation of polar function group.

Each corona pattern 22b is formed by means of corona discharge technology to improve the adhesive force of the surface of the detachable layer 21. If the detachable layer 21 is subjected to the corona surface treatment, charged particles in the corona collide against a film surface to thus cause the film surface to be oxidized. Accordingly, surface energy of the film is increased by means of a polar group generated by the surface oxidization, for example, C═O, C—O—H, COOH, —COO—, —CO—, and so on, and thus, affinity of the film surface with conductive polymers is improved, so that the adhesive force of the film is enhanced. In addition to the chemical polar group, further, a cross-linking structure among polymer molecules is formed under the corona surface treatment, so that the adhesive force of the film is enhanced. Typically, the corona surface treatment is carried out by locating the detachable layer 21 between both electrodes on which corona discharge occurs and by supplying given power to both electrodes to generate corona discharge, and an adhesive force on the surface is treated in the range of 0.1 to 1000 gf/25 mm.

Each deposited pattern 22c is composed of a single layer or multiple layers made of at least one selected from gold (Au), silver (Ag), silicon (Si), copper (Cu), palladium (Pd), nickel (Ni), tungsten (W), iron (Fe), cobalt (Co), titanium (Ti), Chrome (Cr), manganese (Mn), zinc (Zn), zirconium (Zr), molybdenum (Mo), iridium (Ir), ruthenium (Ru), tantalum (Ta), and alloys or oxides thereof. The deposited pattern 22c is deposited to an angstrom thickness, and generally, the deposited pattern 22c enhances an adhesive force of the detachable layer 21. The deposited pattern 22c may be formed by means of masking, which is not necessarily limited thereto.

The plasma patterns 22a, the corona patterns 22b, and the deposited patterns 22c have different mechanisms from one another, so that they have different adhesive forces. In the view of the control in the adhesive force, in this case, the plasma patterns 22a, the corona patterns 22b, and the deposited patterns 22c have the same functions as one another. In view of the adhesive force, however, the plasma patterns 22a, the corona patterns 22b, and the deposited patterns 22c have different characteristics from one another. An object of the present invention is to control the adhesive force of the detachable control layer 20. To do this, the respective adhesive forces of the plasma patterns 22a, the corona patterns 22b, and the deposited patterns 22c are utilized. Accordingly, the respective adhesive forces of the plasma patterns 22a, the corona patterns 22b, and the deposited patterns 22c are not equal to one another. That is, the combination of the detachable layer 21 and the plasma patterns 22a, the combination of the detachable layer 21 and the corona patterns 22b, and the combination of the detachable layer 21 and the deposited patterns 22c have different adhesive forces from one another.

If the plasma patterns 22a, the corona patterns 22b, and the deposited patterns 22c are combined appropriately, the adhesive force of the detachable control layer 20 can be freely controlled according to positions so that the detachable attachment can be easily carried out regardless of a flat or curved shape. In case of the deposited patterns 22c, however, deposition equipment and deposition processes for the deposition can be separately prepared and performed, so that the deposited patterns 22c are selectively used in consideration of costs when compared to the plasma patterns 22a and the corona patterns 22b. That is, if an adhesive force is sufficiently obtained by the plasma patterns 22a, the corona patterns 22b, or the combinations thereof, it is not necessary to use the deposited patterns 22c. Accordingly, more desirably, the surfaced-treated patterns 22 are composed of the plasma patterns 22a, the corona patterns 22b, or the combinations thereof.

FIG. 2 is an exploded sectional view showing a display device 200 according to a second embodiment of the present invention. In this case, the display device 200 is the same as the display device 100 except that it includes an adhesion control layer 31. Accordingly, an explanation on the same reference numerals as in the display device 100 will be avoided.

As shown in FIG. 2, the adhesion control layer 31 is provided in the form of a single layer or pattern. So as to allow the adhesion control layer 31 to be composed of the single layer, for example, a coating layer for lowering the adhesive force through a large contact angle is formed by depositing titanium oxide (TiO₂) or silicon dioxide (SiO₂) on the adherend member 30 to allow a fluoro resin, a silicone resin, or a mixture thereof to be coated on the deposited adherend member 30, thereby providing fingerprint prevention, contamination prevention, and slip characteristics. In this case, the fluoro resin or silicone resin is formed by means of easy cleaning coating (ECC).

So as to allow the adhesion control layer 31 to be composed of the pattern, at least one of a hard coating layer, a digital print layer, a coating layer for adjusting a contact angle, a deposited layer, a fine concave and convex layer with fine concaves and convexes, and a surface-treated layer is arranged in the form of a pattern. The hard coating layer may be a thermal-cured hard coating layer or ultraviolet curable hard coating layer. The thermal-cured hard coating layer may be freely selected within the scope of the present invention. For example, the thermal-cured hard coating layer is selected from an acrylic resin containing hydroxyl group, an acrylic resin containing hydroxyl group and having a weight average molecular weight in the range of 100,000 to 1,500,000, a resin composition with blocked isocyanate as a main component, a composition with an acrylic resin containing hydroxyl group and blocked isocyanate as necessary components, and a composition with a compound two or more functional groups responsible to isocyanate in one molecule and blocked isocyanate.

The ultraviolet curable hard coating layer is made by mixing, for example, a plurality of acrylic monomers and an ultraviolet curing catalyst with a polyurethane resin, an epoxy resin, or a polyester resin. For example, the ultraviolet curable material is made by mixing urethane acrylate oligomer as an ultraviolet reactive coating material, a reactive monomer, a photoinitiator, and a leveling agent with one another. The urethane acrylate oligomer contains, an aliphatic compound, a cyclic aliphatic compound, an aromatic compound, or an oligomer of the compounds and has a chemical formula in which a polyester polyol or polyether polyol is contained in a molecular structure. The reactive monomer is made by mixing trimethylolpropane triacrylate, hexanediol diacrylate, pentaerythritol triacrylate, and dipentaerythritol hexaacrylate at appropriate ratios in consideration of hardness and adhesive force. The photoinitiator is used with a general polymerization initiator that becomes activated by means of ultraviolet rays, and especially, hydroxycyclohexyl phenyl ketone, benzophenone, and phenyl-2-hydroxy-2-phenyl ketone are generally used as the photoinitiator.

The digital print layer is a layer that is printed digitally. For example, a coating layer for raising the adhesive force through a small contact angle is made by coating an organic silicone compound. For example, a coating layer for lowering the adhesive force through a large contact angle is formed by depositing titanium oxide (TiO₂) or silicon dioxide (SiO₂) on the adherend member 30 to allow a fluoro resin, a silicone resin, or a mixture thereof to be coated on the deposited adherend member 30, thereby providing fingerprint prevention, contamination prevention, and slip characteristics. In this case, the fluoro resin or silicone resin is formed by means of easy cleaning coating (ECC).

The deposited layer is composed of a single layer or multiple layers made of at least one selected from gold (Au), silver (Ag), silicon (Si), copper (Cu), palladium (Pd), nickel (Ni), tungsten (W), iron (Fe), cobalt (Co), titanium (Ti), Chrome (Cr), manganese (Mn), zinc (Zn), zirconium (Zr), molybdenum (Mo), iridium (Ir), ruthenium (Ru), tantalum (Ta), and alloys or oxides thereof. The deposited layer controls the adhesive force to the detachable control layer 20.

The fine concave and convex layer is molded to the shape of any one selected from square, triangular, and circular sections or made with beads or beads and binders. That is, sectional shapes of the fine concave and convex layer have angles, curvatures, or combinations thereof. The fine concave and convex layer is semi-transparent to cause permittivity of light to become lowered. The detachable control layer 20 deeply enter the fine concave and convex layer, so that the coupling force between the detachable control layer 20 and the fine concave and convex layer can be enhanced. The surface-treated layer is formed by allowing a surface of a transparent high polymer film to be subjected to plasma or corona treatment or continuous plasma and corona treatments, so that the adhesive force of the surface-treated layer with the detachable control layer 20 can be controlled.

According to the present invention, the attachment force of the detachable control layer 20 is dependent according to the adhesion control layer 31. For example, the attachment force generated when the plasma patterns 22a of the detachable control layer 20 come into contact with the digital print layer of the adhesion control layer 31 is different from that generated when the plasma patterns 22a of the detachable control layer 20 come into contact with the deposited layer of the adhesion control layer 31. The attachment force is designed according to the kind and shape of the display device.

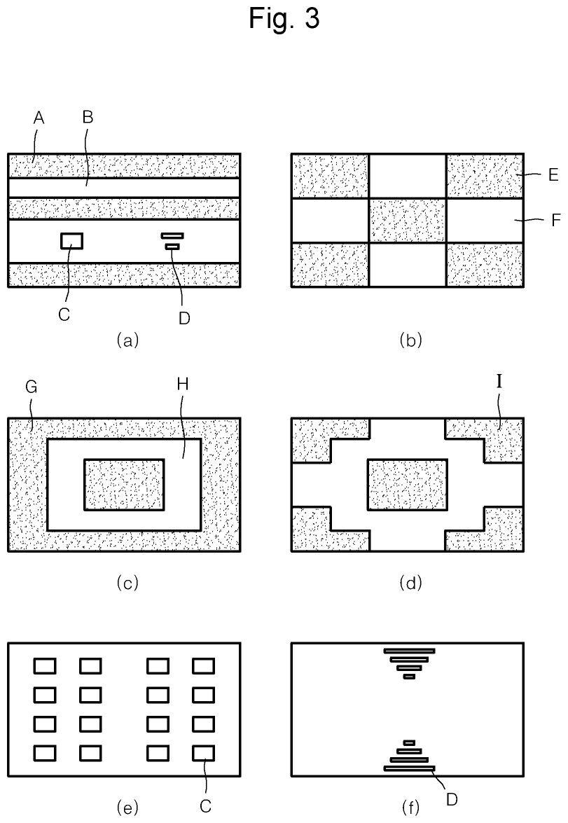

FIGS. 3a to 3f are plan views showing examples of arrangements of surface-treated patterns applied to the display devices 100 and 200 according to the first and second embodiments of the present invention. In this case, some pattern arrangements as shown in FIGS. 3a, 3b, 3c, and 3d are just suggested, and of course, the pattern arrangements may be freely changed within the scope of the present invention.

As shown in FIGS. 3a to 3f, the pattern arrangements are made by allowing the detachable control layer 20 to be partially surface-treated, not to be entirely surface-treated. That is, the pattern arrangements as shown in FIGS. 3a, 3b, 3c, and 3d exist on the detachable control layer 20. The pattern arrangements as shown in FIGS. 3a, 3b, 3c, and 3d utilize various plan pattern shapes. Specifically, stripe-shaped patterns A extended in longitudinal directions of the pattern arrangements as shown in FIGS. 3a, 3b, 3c, and 3d, patterns B with the same shape as the patterns A and having an adhesive force different from the patterns A, single island-shaped patterns C, a plurality of islands-shaped patterns D, patterns E enlarged from the patterns C, patterns F with the same shape as the patterns E and having an adhesive force different from the patterns E, fence-shaped patterns G, fence-shaped patterns H having an adhesive force different from the patterns G, and patterns I located on corners of the pattern arrangements as shown in FIGS. 3a, 3b, 3c, and 3d. The adhesive forces are controllable by means of degrees of surface treatments.

According to the present invention, as the plasma patterns, the corona patterns, and the deposited patterns are combined appropriately, the adhesive force of the detachable control layer can be freely controlled according to positions so that the detachable control layer can be stably attached regardless of whether the surface is flat or curved. If the detachable control layer is stably attached, no separation occurs and removal of air bubbles is easy.

In the figures, the examples of the pattern arrangements as shown in FIGS. 3a, 3b, 3c, and 3d are suggested. The pattern arrangements as shown in FIGS. 3a, 3b, 3c, and 3d include the stripe shaped patterns as shown in FIG. 3a, the lattice shaped patterns as shown in FIG. 3b, island shaped patterns as shown in FIGS. 3a, 3e, and 3f, the fence shaped patterns as shown in FIG. 3c, and the combined shaped patterns as shown in FIGS. 3c and 3d. The patterns of the pattern arrangements as shown in FIGS. 3a, 3b, 3c, and 3d and the arrangements of the patterns are not limited to those mentioned above, but they may be freely changed by those skilled in the art, without departing from the scope of the present invention.

[Explanation of Reference Numerals]

| | |
|---|---|
| 100, 200: display device | |
| 10: adhesive member | 20: detachable control layer |
| 21: detachable layer | 22: surface-treated pattern |
| 22a: plasma pattern | 22b: corona pattern |
| 22c: deposited pattern | 30: adherend member |
| 31: adhesion control layer | |

1. A display device comprising:
an adherend member to which an adhesive member is attached; and
a detachable control layer located on any one of the adhesive member and the adherend member,
wherein the detachable control layer comprises:
a detachable layer; and
surface-treated patterns located on the detachable layer and composed of at least ones selected from plasma patterns, corona patterns, and combinations thereof.

2. The display device according to claim 1, wherein the adhesive member is at least any one selected from module components constituting the display device and a protective sheet.

3. The display device according to claim 1, wherein the adherend member is at least any one selected from module components constituting the display device and a protective sheet.

4. The display device according to claim 1, wherein the adherend member has a flat shape, a curved shape, or a combined shape thereof.

5. The display device according to claim 1, wherein the adherend member is foldable, rollable, or flexible.

6. The display device according to claim 1, wherein arrangements of the surface-treated patterns have stripe shapes, lattice shapes, island shapes, fence shapes, and combined shapes thereof.

7. The display device according to claim 1, wherein the detachable layer is provided in any one form of a coating and a sheet.

8. The display device according to claim 1, wherein the plasma patterns are formed by allowing the detachable layer to be subjected to any one selected from an atmospheric plasma treatment, a low pressure plasma treatment, and a corona plasma treatment.

9. The display device according to claim 1, wherein the corona patterns are formed by allowing the surface of the detachable layer to be oxidized to thus express a polar group.

10. The display device according to claim 1, wherein the surface-treated patterns are further composed of deposited patterns.

11. The display device according to claim 10, wherein each deposited pattern is a single deposited layer or multiple deposited layers made of at least one selected from titanium oxide (TiO₂), silicon dioxide (SiO₂), gold (Au), silver (Ag), silicon (Si), copper (Cu), palladium (Pd), nickel (Ni), tungsten (W), iron (Fe), cobalt (Co), titanium (Ti), Chrome (Cr), manganese (Mn), zinc (Zn), zirconium (Zr), molybdenum (Mo), iridium (Ir), ruthenium (Ru), tantalum (Ta), and alloys or oxides thereof, and a layer in which a fluoro resin or silicone resin is contained is located on the deposited layer.

12. A display device comprising:
an adherend member to which an adhesive member is attached; and
a detachable control layer located on any one of the adhesive member and the adherend member,
wherein the detachable control layer comprises:
a detachable layer; and
surface-treated patterns located on the detachable layer and composed of deposited patterns.

13. The display device according to claim 12, wherein each deposited pattern is a single deposited layer or multiple deposited layers made of at least one selected from titanium oxide (TiO₂), silicon dioxide (SiO₂), gold (Au), silver (Ag), silicon (Si), copper (Cu), palladium (Pd), nickel (Ni), tungsten (W), iron (Fe), cobalt (Co), titanium (Ti), Chrome (Cr), manganese (Mn), zinc (Zn), zirconium (Zr), molybdenum (Mo), iridium (Ir), ruthenium (Ru), tantalum (Ta), and alloys or oxides thereof, and a layer in which a fluoro resin or silicone resin is contained is located on the deposited layer.

14. The display device according to claim 12, wherein the adhesive member is at least any one selected from module components constituting the display device and a protective sheet.

15. The display device according to claim 12, wherein the adherend member is at least any one selected from module components constituting the display device and a protective sheet.

16. The display device according to claim 12, wherein the adherend member has a flat shape, a curved shape, or a combined shape thereof.

17. The display device according to claim 12, wherein the adherend member is foldable, rollable, or flexible.

18. The display device according to claim 12, wherein the detachable layer is provided in any one form of a coating or a sheet.
